(19) United States
(12) Patent Application Publication
(10) Pub. No.: US 2016/0028048 A1
(43) Pub. Date: Jan. 28, 2016

(54) LITHIUM BATTERY AND METHOD OF MANUFACTURING THE SAME

(71) Applicant: ELECTRONICS AND TELECOMMUNICATIONS RESEARCH INSTITUTE, Daejeon (KR)

(72) Inventors: Young-Gi LEE, Daejeon (KR); Kwang Man KIM, Daejeon (KR); Kunyoung KANG, Daejeon (KR); Dong Ok SHIN, Daejeon (KR)

(73) Assignee: ELECTRONICS AND TELECOMMUNICATIONS RESEARCH INSTITUTE, Daejeon (KR)

(21) Appl. No.: 14/802,269

(22) Filed: Jul. 17, 2015

(30) Foreign Application Priority Data
Jul. 28, 2014 (KR) 10-2014-0095517
Apr. 28, 2015 (KR) 10-2015-0059969

(51) Int. Cl. H01M 2/02; H01M 2/30; H01M 10/052

(52) U.S. Cl. CPC H01M 2/0202; H01M 10/052; H01M 2/30; H01M 2220/30

(57) ABSTRACT

An embodiment of the inventive concept provides a lithium battery including: a first pouch film; a first anode part on the first pouch film, the first anode part including a first anode terminal; a second cathode part on the first anode part; a polymer film on the second cathode part; a second anode part on the polymer film, the second anode part including a second anode terminal; a first cathode part on the second anode part; a second pouch film on the first cathode part; and an anode connector configured to penetrate the first and second anode terminals to provide an electrical connection between the first anode part and the second anode part.

### CROSS-REFERENCE TO RELATED APPLICATIONS

This U.S. non-provisional patent application claims priority under 35 U.S.C. §119 of Korean Patent Application Nos. 10-2014-0095517, filed on Jul. 28, 2014, and 10-2015-0059969, filed on Apr. 28, 2015, the entire contents of which are hereby incorporated by reference.

### BACKGROUND

The present disclosure herein relates to a lithium battery, and more particularly, to a laminated solid-state lithium battery.

As technologies related to energy storage and energy conversion have become more important, interest in lithium secondary batteries has increased significantly. Lithium batteries may include cathodes, separators, anodes, and electrolytes. The electrolytes are made of lithium salts and solvents which are able to dissociate the lithium salts, and serve as media that facilitate a movement of ions between the cathodes and the anodes. Lithium batteries have a very high energy density compared to other batteries and can be manufactured to be small and light. Thus, lithium batteries are being actively developed to be used as a power source for mobile electronics devices. Recently, as the performance of mobile electronics devices has improved, power consumed in the mobile electronics devices has increased. There is a need for lithium batteries with high power and satisfactory discharge characteristics. Moreover, there is a need for methods that employ automation, continuous processing and mass production to manufacture lithium batteries.

### SUMMARY

The present disclosure provides a lithium battery having a high capacity and a method of manufacturing the same.

The present disclosure also provides a simple method of manufacturing a lithium battery which is connected in parallel.

An embodiment of the inventive concept provides a lithium battery including: a first pouch film; a first anode part on the first pouch film, the first anode part including a first anode terminal; a second cathode part on the first anode part; a polymer film on the second cathode part; a second anode part on the polymer film, the second anode part including a second anode terminal; a first cathode part on the second anode part; a second pouch film on the first cathode part; and an anode connector configured to penetrate the first and second anode terminals to provide an electrical connection between the first anode part and the second anode part.

In an embodiment, the polymer film may include a first surface and a second surface opposite to the first surface, the first surface facing the first pouch film; the first anode part may include a first anode current collector, a first anode layer, and a first anode electrolyte layer which are laminated on the first pouch film; the second cathode part may include a second cathode current collector, a second cathode layer, and a second cathode electrolyte layer which are laminated on the first surface of the polymer film; the second anode part may include a second anode current collector, a second anode layer, and a second anode electrolyte layer which are laminated on the second surface of the polymer film; and the first cathode part may include a first cathode current collector, a first cathode layer, and a first cathode electrolyte layer which are laminated on the second pouch film.

In an embodiment, the first anode electrolyte layer may face and contact the second cathode electrolyte layer, and the second anode electrolyte layer may face and contact the first cathode electrolyte layer.

In an embodiment, the first anode electrolyte layer may include the same material as the first cathode electrolyte layer, the second anode electrolyte layer and the second cathode electrolyte layer.

In an embodiment, the polymer film may include a third surface configured to connect the first surface to the second surface; and the third surface of the polymer film may be not covered by the second cathode electrolyte layer and the second anode electrolyte layer.

In an embodiment, each of the second cathode part, the second anode part and the polymer film may be provided in plurality, in which the second cathode electrolyte layer of each of the second cathode parts may face and contact the second anode electrolyte layer of each of the second anode parts that are adjacent to the second cathode parts.

In an embodiment, the first cathode part may include a first cathode terminal; and the second cathode part may include a second cathode terminal; the lithium battery may further include a cathode connector configured to penetrate the first cathode terminal and the second cathode terminal to provide an electrical connection between the first cathode part and the second cathode part.

In an embodiment, the first anode part and the second cathode part may form a first unit cell, and the second anode part and the first cathode part may form a second unit cell; the first unit cell my be connected to the second unit cell in parallel.

In an embodiment, the first unit cell may have the same voltage and capacity as the second unit cell.

In an embodiment, the first anode terminal may be connected, on the first pouch film, to the first anode current collector, and protrude horizontally from the first anode current collector; and the second anode terminal may be connected, on the polymer film, to the second anode current collector, and protrude horizontally from the second anode current collector.

In an embodiment, the first cathode part may include a first cathode terminal; and the second cathode part may comprise a second cathode terminal, the first cathode terminal may be connected, on the pouch film, to the first cathode current collector, and protrude horizontally from the first cathode current collector, and the second cathode terminal may be connected, on the polymer film, to the second cathode current collector, and protrude horizontally from the second cathode current collector.

In an embodiment, each of the second cathode part, the second anode part and the polymer film may be provided in plurality, number of the second cathode parts may be equal to number of the second anode parts and number of the polymer films; and each of the polymer films may be disposed between one of the second cathode parts and one of the second anode parts

An embodiment of the inventive concept provides a method of manufacturing a lithium battery including: forming a first anode part on a first pouch film, the first anode part including a first anode current collector, a first anode terminal, a first anode layer and a first anode electrolyte layer which are laminated on the first pouch film; forming a first cathode part on a second pouch film, the first cathode part including a first cathode current collector, a first cathode terminal, a first cathode layer and a first cathode electrolyte layer which are laminated on the second pouch film; providing a double-sided electrode, the double-sided electrode including a polymer film having a first surface and a second surface, a second cathode part which is disposed on the first surface and has a second cathode terminal, and a second anode part which is disposed on the second surface and has a second anode terminal; connecting the first cathode part, the first anode part and the double-sided electrode; forming an anode connection that penetrates the first anode terminal and the second anode terminal to connect the first anode terminal and the second anode thermal, and a cathode connection that penetrates the first cathode terminal and the second cathode terminal to connect the first cathode terminal and the second cathode terminal.

In an embodiment, the first anode part and the second cathode part may form a first unit cell, and the second anode part and the first cathode part may form a second unit cell, the first unit cell may be connected to the second unit cell in parallel through the cathode connection and the anode connection.

In an embodiment, the providing of the double-sided electrode may include: forming the second cathode part by laminating, on the first surface of the polymer film, a second cathode current collector, a second cathode layer and a second cathode electrolyte layer; and forming the second anode part by laminating, on the second surface of the polymer film, a second anode current collector, a second anode layer and a second anode electrolyte layer.

In an embodiment, the connecting of the first cathode part, the first anode part and the double-sided electrode may include thermally bonding the first cathode part, the first anode part, and the double-sided electrode at a temperature in the range of about 100° C. to about 160° C.

In an embodiment, the polymer film may have a third surface configured to connect the first surface to the second surface, and the third surface is may be not covered by the second cathode electrolyte layer and the second anode electrolyte layer.

In an embodiment, first anode electrolyte layer may face and contact the second cathode electrolyte layer; and the second anode electrolyte layer may face and contact the first cathode electrolyte layer.

In an embodiment, the first anode electrolyte layer, the first cathode electrolyte layer, the second anode electrolyte layer, and the second cathode electrolyte layer may include the same material.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIGS. 1A, 2A, 3A and 4A are plan views illustrating a method of manufacturing a lithium battery according to an embodiment of the inventive concept;

FIG. 1B is a cross-sectional view taken along line I-I′ of FIG. 1A;

FIG. 2B is a cross-sectional view taken along line II-II′ of FIG. 2A;

FIG. 3B is a cross-sectional view taken along line III-III′ of FIG. 3A;

FIG. 4B is a cross-sectional view taken along line IV-IV′ of FIG. 4A.

FIG. 4C is a cross-sectional view taken along line V-V′ of FIG. 4A;

FIG. 5A is a cross-sectional view taken along line IV-IV′ of FIG. 4A, illustrating a lithium battery according to another embodiment of the inventive concept;

FIG. 5B is a cross-sectional view taken along line V-V′ of FIG. 4A, illustrating a lithium battery according to another embodiment of the inventive concept;

FIG. 6 is a graph showing evaluation results of discharge characteristics of the lithium batteries according to Experimental Examples and Comparative Examples;

FIG. 7 is a graph showing evaluation results of impedance characteristics of the lithium batteries according to Experimental Examples and Comparative Examples; and

FIG. 8 is a graph showing evaluation results of lifetime characteristics of the lithium batteries according to Experimental Examples and Comparative Examples.

### DETAILED DESCRIPTION

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The inventive concepts of the disclosure are defined solely by the claims. Like reference numerals refer to like elements throughout the specification.

Terms used herein are merely provided for illustration of specific embodiments, and not limited to the inventive concept. A singular form, unless otherwise indicated, includes a plural form. The term “comprises” and/or “comprising” intends to mean that there may be specified elements, steps, operations, devices, or combinations thereof, not excluding the possibility of the presence or addition of the specified elements, steps, operations, devices, or combinations thereof.

Additionally, embodiments described herein will be described with reference to cross-sectional views and/or plan views as ideal exemplary views of the embodiments of the inventive concept. In the drawings, the dimensions of layers and regions are exaggerated for clarity of illustration. Accordingly, shapes of the exemplary views may be modified according to manufacturing techniques and/or allowable errors. Therefore, the embodiments of the inventive concept are not limited to the specific shape illustrated in the exemplary views, but may include other shapes that may be modified according to manufacturing processes. For example, an etched region illustrated as a rectangle may have rounded or curved features. Therefore, areas exemplified in the drawings have general properties, and are used to illustrate a specific shape of a device. Thus, this should not be construed as limited to the scope of the inventive concept.

Hereinafter, a lithium battery and a method of manufacturing the same according to an embodiment of the inventive concept will be described in detail with reference to the accompanying drawings.

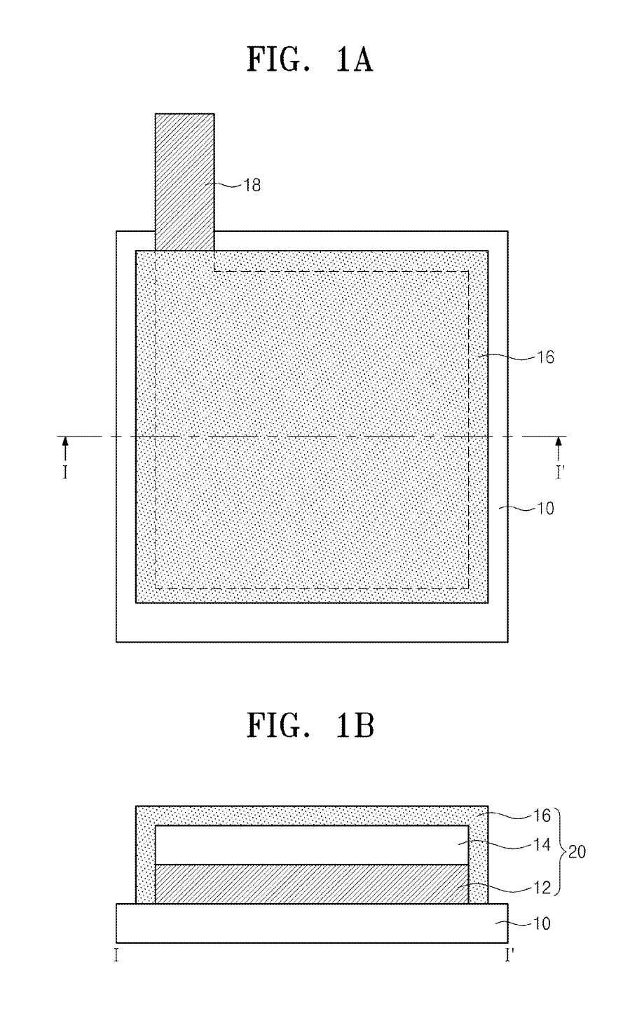

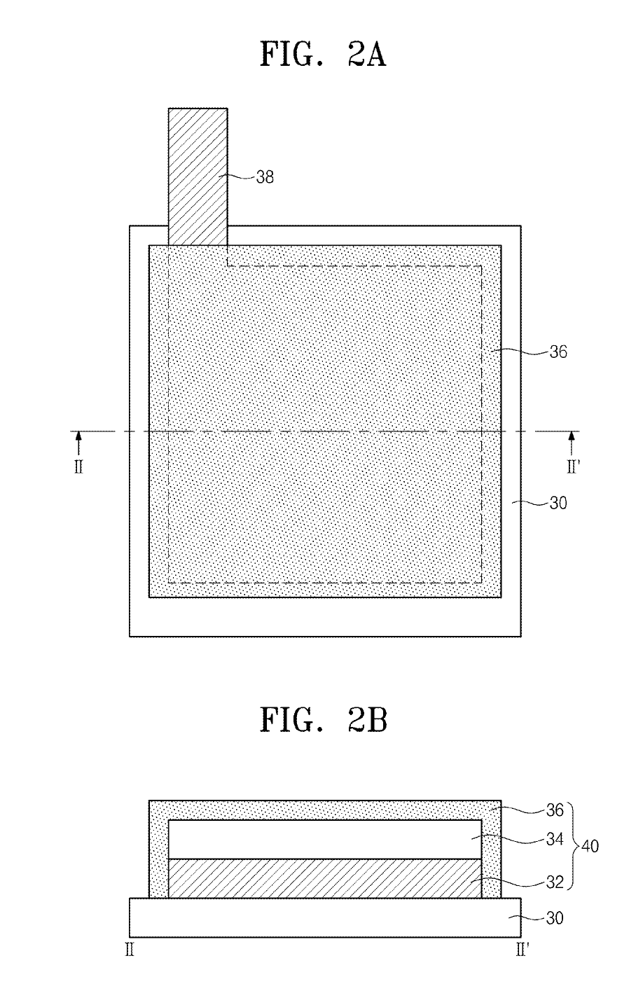

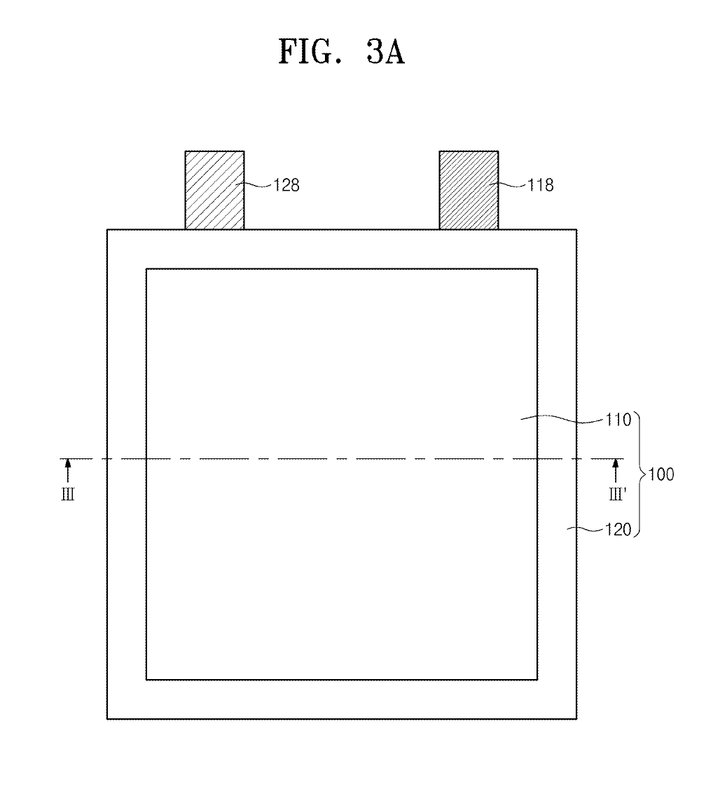

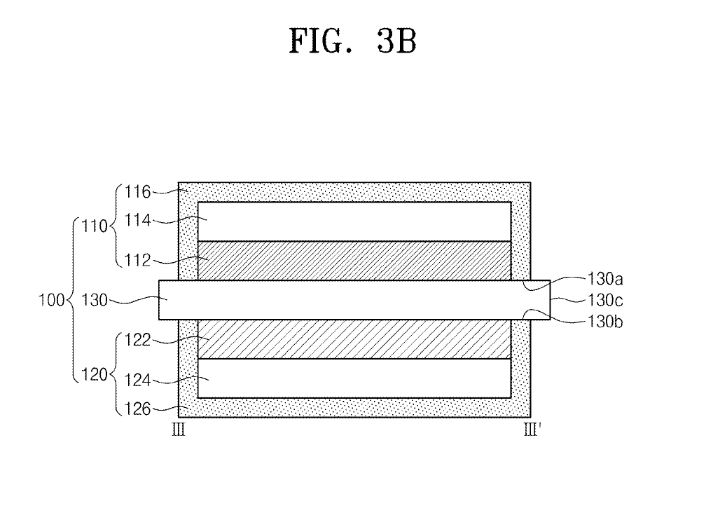

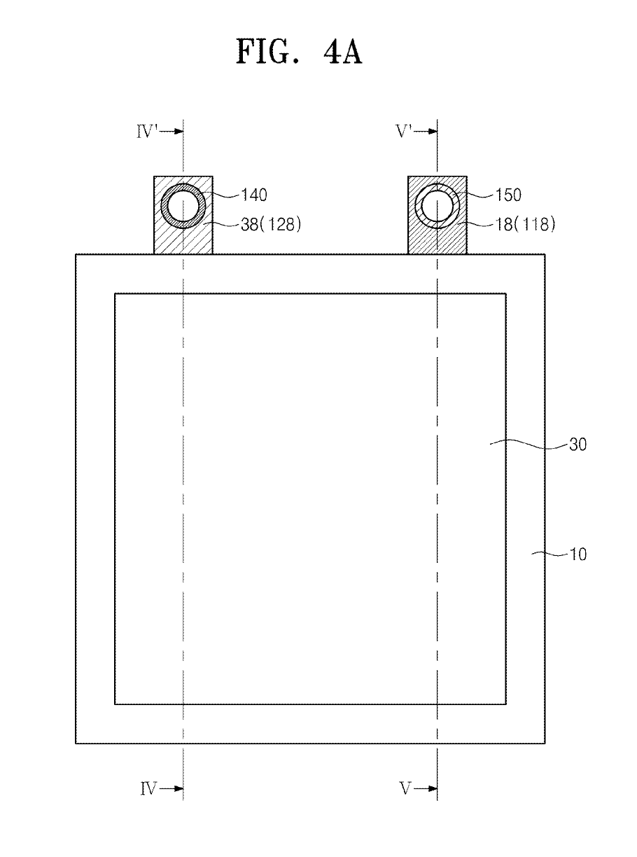

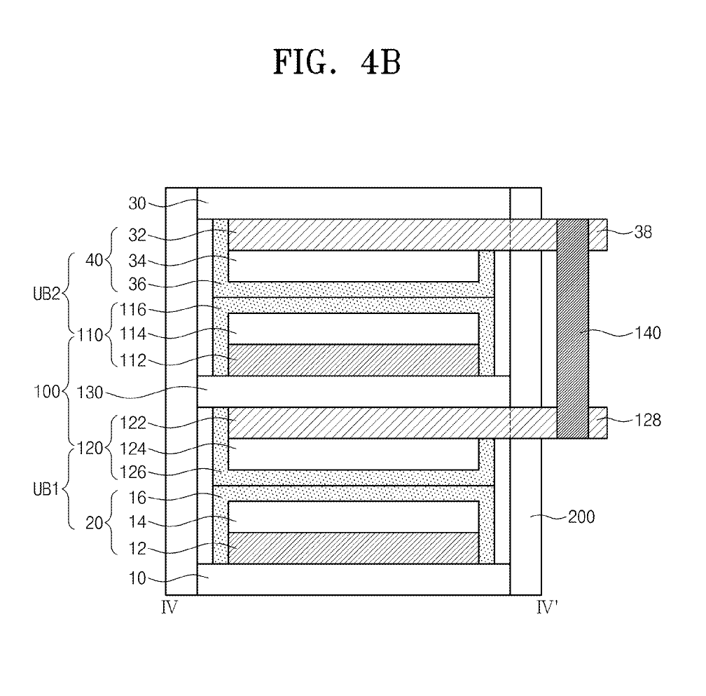

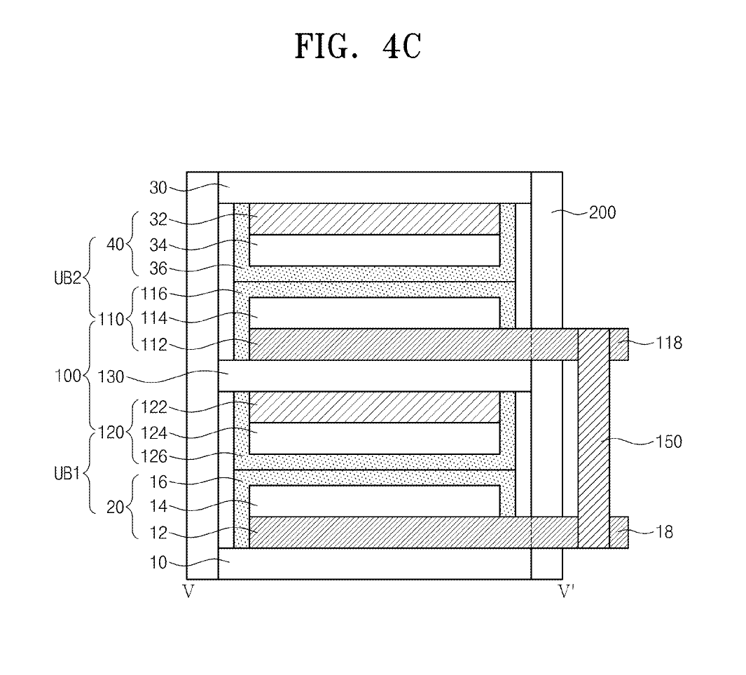

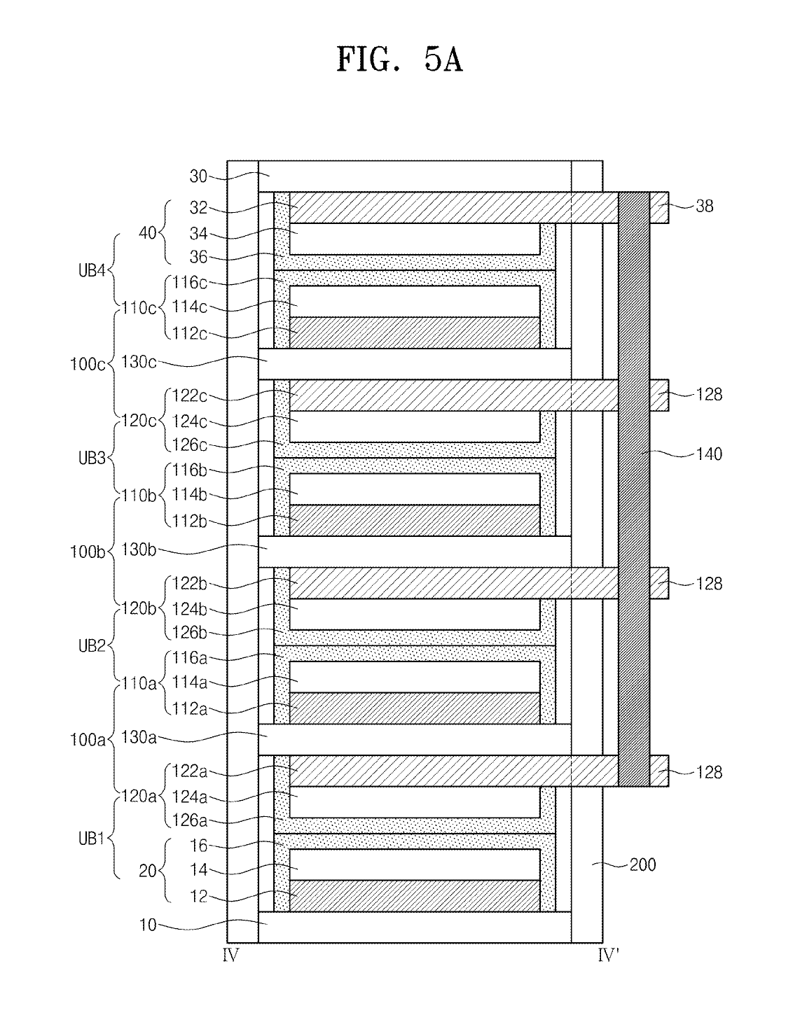

FIGS. 1A, 2A, 3A and 4A are plan views illustrating a method of manufacturing a lithium battery according to an embodiment of the inventive concept. FIG. 1B is a cross-sectional view taken along line I-I′ of FIG. 1A. FIG. 2B is a cross-sectional view taken along line II-II′ of FIG. 2A. FIG. 3B is a cross-sectional view taken along line III-III′ of FIG. 3A. FIG. 4B is a cross-sectional view taken along line IV-IV′ of FIG. 4A. FIG. 4C is a cross-sectional view taken along line V-V′ of FIG. 4A.

Referring to FIGS. 1A and 1B, a first anode part 20 may be formed on a first pouch film 10. The first pouch film 10 may include an insulating film; a first resin film such as a polypropylene film on one surface of the insulating film, and a second resin film such as a nylon film on the other surface of the insulting film. The first anode part 20 may include a first anode current collector 12, a first anode layer 14, and a first anode electrolyte layer 16. The first pouch film 10 may include a metal layer such as an aluminum layer, a polymer composite layer, and combinations thereof; and may have a multi-layered structure. A top surface of the first pouch film 10 may be subjected to surface treatment. For example, the surface treatment may include applying plasma to the top surface of the first pouch film 10 in an atmospheric condition. The plasma treatment may cause a functional group such as a radical to be formed on the top surface of the first pouch film 10, so that the surface energy of the top surface may increase.

The first anode current collector 12 and an anode terminal 18 may be formed on the first pouch film 10. For example, a metal foil may be attached to the top surface of the first pouch film 10 to form the first anode current collector 12. The metal foil may be attached using a lamination process. For another example, the first anode current collector 12 may be formed using a deposition process such as sputtering. The top surface of the first pouch film 10 having a high surface energy may allow the first anode current collector 12 to be attached well to the first pouch film 10. The first anode current collector 12 may have a smaller cross-sectional area than the first pouch film 10. The first anode current collector 12 may be formed to have a thickness of about 2 μm to about 20 μm. The anode terminal 18 may contact, on the first pouch film 10, the first anode current collector 12, and protrude from the first anode current collector 12. The anode terminal 18 and the first anode layer 14 may be formed simultaneously. Accordingly, a separate process for forming the anode terminal 18 may be omitted. The first anode current collector 12 and the anode terminal 18 may include a metal such as copper, nickel, stainless steel (for instance, steel use stainless (SUS)), titanium, or an alloy thereof. The first anode current collector 12 and the anode terminal 18 may be a solid.

The first anode layer 14 may be formed on the first anode current collector 12. The first anode layer 14 may be formed to have a cross-sectional area equal to or smaller than the first anode current collector 12. The first anode layer 14 may have a thickness of about 15 μm to about 150 μm. For example, the anode layer 14 may be formed by screen printing an anode paste on the anode current collector 12. The anode paste may be prepared by mixing an anode active material, a conductive agent, and an electrolyte paste at a weight ratio of about 6:2:2 to about 9.8:0.1:0.1. The anode active material may include a carbonaceous material (such as graphite, hard carbon, soft carbon, or tin) or a non-carbonaceous material (such as tin, silicon, lithium titanium oxide (Li_{X}TiO₂) nanotube, or spinel lithium titanium oxide (Li₄Ti₅O₁₂) which is coated with carbon particles). The conducting agent may include at least one of graphite, hard carbon, soft carbon, carbon fiber, carbon nanotube, carbon black, acetylene black, ketjen black, or Lonza carbon. The electrolyte paste will be discussed below. The first anode layer 14 may be formed by performing drying and roll pressing processes following the screen printing process. For another example, the first anode layer 14 may be formed by attaching a compressed lithium foil to the first anode current collector 12. The first anode layer 14 may be a solid.

The first anode electrolyte layer 16 may be formed by screen printing electrolyte paste on the first anode layer 14. After the screen printing, the first anode electrolyte layer 16 may be dried. The first anode electrolyte layer 16 may be formed to cover the first anode current collector 12 and the first anode layer 14. For example, the first anode electrolyte layer 16 may contact a top surface and a side surface of the first anode layer 14, and a side surface of the first anode current collector 12. Referring to FIG. 1A, the anode terminal 18 may be not covered by the first anode electrolyte layer 16. The first anode electrolyte layer 16 may have a thickness of about 5 μm to about 150 μm. The first anode electrolyte layer 16 may be a solid.

Electrolyte paste may be produced by mixing a cellulose-based polymer and a polyvinylidene fluoride-based polymer to form a mixture, then dissolving the mixture in a solvent to produce a solution, and subsequently adding a non-aqueous electrolyte solution and an inorganic material to the solution. The cellulose-based polymer and the polyvinylidene fluoride-based polymer may be mixed at a weight ratio of about 1:99 to about 99:1. The cellulose-based polymer may have a strong adhesion and include cellulose, ethyl cellulose, butyl cellulose, carboxyl methyl cellulose, or hydroxypropyl cellulose. The polyvinylidene fluoride-based polymer may have a film formation characteristic, and include polyvinyl chloride derivatives, acrylonitrile-based polymer derivatives, polyvinylidene fluoride, a copolymer of vinylidene fluoride and hexafluoro propylene, a copolymer of vinylidene fluoride and trifluoro ethylene, a copolymer of vinylidene fluoride and tetrafluoro ethylene, polymethyl methacrylate, polyethyl acrylate, polyethyl methacrylate, polybutyl acrylate, polybutyl methacrylate, polyvinyl acetate, polyvinyl alcohol, polyimide, polysulfone, or polyurethane.

The non-aqueous electrolyte solution may be an organic solvent in which lithium salts are dissolved. The organic solvent may include at least one of ethylene carbonate, propylene carbonate, ethyl methyl carbonate, gamma-butyrolactone, ethylene glycol, triglyme, polyethylene oxide, or polyethylene glycol dimethyl ether. The lithium salt may include at least one of lithium perchlorate (LiClO₄), lithium triflate (LiCF₃SO₃), lithium hexafluoro phosphate (LiPF₆), lithium tetrafluoro borate (LiBF₄), or lithium trifluoro methane sulfonyl imide (LiN(CF₃SO₂)₂).

The inorganic material may include an oxide-based inorganic particle, for example, lithium aluminum titanium phosphate (LATP), lithium aluminum germanium phosphate (LAGP), lithium lanthanum zirconium oxide (LLZO), lithium lanthanum titanium oxide (LLTO), lithium lanthanum niobium oxide (LLNO), lithium lanthanum tallium oxide (LLTO) or lithium barium lanthanum tallium oxide (LBLTO). The inorganic material may be a ceramic solid electrolyte particle. The inorganic particle may have a size of about 500 nm to about 50 mm. The electrolyte paste may also be used in the preparation of the above-described anode paste and a cathode paste to be described later, as well as the formation of the first anode electrolyte layer 16. The first pouch film 10, the first anode current collector 12, the first anode layer 14, and the first anode electrolyte layer 16 may be laminated sequentially according to the above-described manufacturing example. The first anode part 20 may be manufactured through a continuous process, which may be effective for automation, continuous processing, and mass production.

Referring to FIGS. 2A and 2B, a first cathode part 40 may be formed on a second pouch film 30. The first cathode part 40 may include a first cathode current collector 32, a first cathode layer 34, and a first cathode electrolyte layer 36. The second pouch film 30 may include the same material as the first pouch film 10, as described in the example of FIGS. 1A and 1B. A top surface of the second pouch film 30 may be subjected to surface treatment, so that the surface energy of the top surface of the second pouch film 30 may increase. The first cathode current collector 32 and a first cathode terminal 38 may be formed on the second pouch film 30. For example, a metal foil may be attached to the top surface of the second pouch film 30 to form a first cathode current collector 32. The metal foil may be attached using a lamination process. For another example, the first cathode current collector 32 may be formed using a deposition process such as sputtering. The first cathode current collector 32 may be formed to have a planar area that is smaller than that of the second pouch film 30. The first cathode current collector 32 may have a thickness of about 2 μm to about 20 μm. The first cathode current collector 32 may include a metal such as aluminum, nickel, stainless steel (for instance, SUS), titanium, or an alloy thereof.

A first cathode terminal 38 may contact the first cathode current collector 32 and protrude from the first cathode current collector 32. The cathode terminal 38 may be formed simultaneously with the first cathode current collector 32, and thus a separate process for forming the cathode terminal 38 may be omitted. The cathode terminal 38 may include the same material and have the same thickness as the first cathode current collector 32. The first cathode layer 34 may be formed by screen printing the cathode paste on the first current collector 32. The first cathode layer 34 may have a planar area that is equal to or smaller than that of the first cathode current collector 32. The cathode paste may be prepared by mixing a cathode active material, a conducting agent, and an electrolyte paste at a weight ratio of about 6:2:2 to about 9.8:0.1:0.1. The cathode active material may include lithium cobalt oxide (LiCoO₂), lithium nickel oxide (LiNiO₂), lithium manganese oxide (LiMn₂O₄), nano-olivine (LiFePO₄) which is coated with carbon particles, or any mixtures or solid solutions thereof. Lithium cobalt oxide (LiCoO₂), lithium nickel oxide (LiNiO₂), and lithium manganese oxide (LiMn₂O₄) may have a size of about 1 μm to about 100 μm. The conducting agent and the electrolyte paste may include the same materials as the conducting agent and the electrolyte paste which are described in the manufacturing example of FIGS. 1A and 1B. Drying and roll pressing may be performed on the first cathode layer 34. The first cathode layer 34 may include a bottom surface which contacts the first cathode current collector 32, a top surface facing the bottom surface, and a side surface which connects the bottom surface to the top surface. The first cathode layer 34 may have a thickness of about 30 μm to about 200 μm.

The first cathode electrolyte layer 36 may be formed by screen printing an electrolyte paste on the first cathode layer 34. The electrolyte paste may include the same material of the electrolyte paste as described in the example of FIGS. 1A and 1B that illustrates the formation of the first anode electrode layer 16. Accordingly, the first cathode electrolyte layer 36 may be prepared with ease. After the screen printing, the first cathode electrolyte layer 36 may be dried. The first cathode electrolyte layer 36 may be formed to cover the first cathode current collector 32 and the first cathode layer 34. For example, the first cathode electrolyte layer 36 may contact a top surface and a side surface of the first cathode layer 34, and a side surface of the first cathode current collector 32. The first cathode electrolyte layer 36 may be disposed to not be formed on the cathode terminal 38, and thus the first cathode terminal 38 may be disposed to not be covered by the first cathode electrolyte layer 36. The first cathode electrolyte layer 36 may be formed to have a thickness of about 5 μm to about 150 μm. Accordingly, the first cathode part 40, including the first cathode current collector 32, the first cathode layer 34, and the first cathode electrolyte layer 36, which are laminated, may be completed. The first cathode part 40 may be manufactured in a single processing step using a continuous process, which may be effective for automation, continuous processing, and mass production.

Referring to FIGS. 3A and 3B, a double-sided electrode 100, including a second anode part 110, a second cathode part 120, and a polymer film 130, may be manufactured. The polymer film 130 may include a first surface 131A and a second surface 131B opposite to the first surface 131A. The first and second surfaces 131A and 131B of the polymer film 130 may be subjected to surface treatment. The surface treatment may be performed by applying plasma to the polymer film 130 in an atmospheric condition. As a result, a functional group such as a radical may be formed on the first and second surfaces 131A and 131B of the polymer film 130, so that the surface energy of the polymer film 130 may increase. The polymer film 130 may be multi-layered. The polymer film 130 may include an insulating polymer, for example, polyethylene, polypropylene, polyethylene terephthalate, polybutylene terephthalate, nylon, polyimide, or combinations thereof. The polymer film 130 may be a solid, and have a function to support the second cathode part 120 and the second anode part 110.

The second anode part 110 may be provided on the first surface 131A of the polymer film 130. The second anode part 110 may be the same or similar to the first anode part 20, as described with reference to FIGS. 1A and 1B. For example, the second anode part 110 may include a second anode current collector 112, a second anode layer 114, and a second anode electrolyte layer 116, which are successively laminated on the first surface 131A of the polymer film 130. The second anode current collector 112, the second anode layer 114, and the second anode electrolyte layer 116 may have the same structure and materials as the first anode current collector 12, the first anode layer 14, and the first anode electrolyte layer 16, which are illustrated in FIGS. 1A and 1B. The second anode current collector 112, a second anode terminal 118, the second anode layer 114, and the second anode electrolyte layer 116 may be formed by the same method used to form the first anode current collector 12, the first anode terminal 18, the first anode layer 14, and the first anode electrolyte layer 16, which are illustrated in FIGS. 1A and 1B. For example, the second anode current collector 112 and the second anode terminal 118 may be deposited or attached to the first surface 131A of the polymer film 130. The second anode terminal 118 and the second anode current collector 112 may be formed simultaneously. The second anode terminal 118 may protrude from the polymer film 130 and the second anode current collector 112. The second anode layer 114 may be formed on the second anode current collector 112. The second anode electrolyte layer 116 may be formed on the second anode layer 114, and thus cover a top surface of the second anode layer 114, a side surface of the second anode layer 114, and a side surface of the second anode current collector 112. The second anode electrolyte layer 116 may be disposed to not cover a third surface 131C of the polymer film 130.

The second cathode part 120 may be formed on the second surface 131B of the polymer film 130. For example, the second cathode part 120 may include a second cathode current collector 122, a second cathode layer 124, and a second cathode electrolyte layer 126 which are laminated sequentially on the second surface 131B of the polymer film 130. The second cathode current collector 122, a second cathode terminal 128, the second cathode layer 124, and the second cathode electrolyte layer 126 may have the same structure and materials as the first cathode current collector 32, the first cathode terminal 38, the first cathode layer 34, and the first cathode electrolyte layer 36, which are illustrated in FIGS. 2A and 2B. The second cathode current collector 122, the second cathode terminal 128, the second cathode layer 124, and the second cathode electrolyte layer 126 may be formed by the same method used to form the first cathode current collector 32, the first cathode terminal 38, the first cathode layer 34, and the first cathode electrolyte layer 36, which are illustrated in FIGS. 2A and 2B. The second cathode terminal 128 and the second cathode current collector 122 may be formed simultaneously. The second cathode terminal 128 may protrude from the polymer film 130 and the second cathode current collector 122. The second cathode electrolyte layer 126 may cover a top surface of the second cathode layer 124, a side surface of the second cathode layer 124, and a side surface of the second cathode current collector 122. The second cathode electrolyte layer 126 may be disposed to not cover a third surface 131C of the polymer film 130.

Referring to FIGS. 4A to 4C, the first anode part 20, the first cathode part 40, and the double-sided electrode 100 may be connected. The first anode part 20 may be manufactured using the method described in the example of FIGS. 1A and 1B. The first cathode part 40 may be manufactured using the method described in the example of FIGS. 2A and 2B. The double-sided electrode 100 may be manufactured using the method described in the example of the double-sided electrode 100 of FIGS. 3A and 3B.

The double-sided electrode 100 may be disposed on the first anode part 20 such that the second cathode part 120 contacts the first anode part 20. The first pouch film 10 on the first anode part 20 may be spaced apart from the double-sided electrode 100. The second cathode electrolyte layer 126 of the double-sided electrode 100 may face and contact the first anode electrolyte layer 16 of the first anode part 20. The second cathode electrolyte layer 126 may include the same material as the first anode electrolyte layer 16, and thus the contact resistance between the electrolyte layers may be low. Accordingly, the electrical properties of a lithium battery may be improved. According to an embodiment, the first anode electrolyte layer 16 and the second cathode electrolyte layer 126 may be disposed between the first anode layer 14 and the second cathode layer 124, so that an electrical short may be prevented from occurring between the first anode layer 14 and the second cathode layer 124.

The first cathode part 40 may be disposed on the double-sided electrode 100 such that the first cathode part 40 contacts the second anode part 110. The second pouch film 30 on the first cathode part 40 may be spaced apart from the double-sided electrode 100. The second anode electrolyte layer 116 of the double-sided electrode 100 may face and contact the first cathode electrolyte layer 36 of the first cathode part 40. The second anode electrolyte 116 layer may include the same material as the first cathode electrolyte layer 36, and thus the contact resistance between the second anode electrolyte layer 116 and the first cathode electrolyte layer 36 may be low. Accordingly, the electrical properties of a lithium battery may be improved. The second anode electrolyte layer 116 and the first cathode electrolyte layer 36 may be disposed between the second anode layer 114 and the first cathode layer 34, so that an electrical short may be prevented from occurring between the second anode layer 114 and the first cathode layer 34.

The order of lamination of the first anode part 20, the double-sided electrode 100, and the first cathode part 40 is not limited thereto and a large variety of orders may be possible. For example, the double-sided electrode 100 may be formed on the first cathode part 40, and the first anode part 20 may be formed on the double-sided electrode 100.

Referring to FIGS. 4A and 4C, the second anode terminal 118 may overlap the first anode terminal 18 vertically. Referring to FIGS. 4A and 4B, the second cathode terminal 128 may overlap the first cathode terminal 38 vertically. The first and second anode terminals 18 and 118 may be spaced apart in a horizontal direction from the first and second cathode terminals 38 and 128.

An anode connector 150 may be disposed within the first and second anode terminals 18 and 118, and simultaneously penetrate the first and second anode terminals 18 and 118. The anode connector 150 may be electrically connected to the first and second anode terminals 18 and 118. In other words, the first and second anode terminals 18 and 118 may be electrically connected through the anode connector 150. A negative voltage may be applied to the anode connector 150. A cathode connector 140 may be disposed within the first and second cathode terminals 38 and 128, and simultaneously penetrate the first and second cathode terminals 38 and 128. The cathode connector 140 may be electrically connected to the first and second cathode terminals 38 and 128. In other words, the first and second cathode terminals 38 and 128 may be electrically connected through the cathode connector 140. A positive voltage may be applied to the cathode connector 140. According to an embodiment of the inventive concept, the anode connector 150 and the cathode connector 140 may be provided in the form of rivets. However, the forms of the anode connector 150 and the cathode connector 140 are not limited thereto and a large variety of connection types may be used as a connector. The connectors may include a conductor such as metal. Manufacturing of a lithium battery may be completed according to the above-described manufacturing example.

The first anode part 20, the double-sided electrode 100, and the first cathode part 40 may be interconnected by thermal bonding. Through the thermal bonding, the first anode electrolyte layer 16 may be connected to the second cathode electrolyte layer 126, and the second anode electrolyte layer 116 may be connected to the first cathode electrolyte layer 36. The thermal bonding may be performed in a vacuum condition at a temperature of about 30° C. to about 160° C., and preferably about 50° C. to about 130° C. When the thermal bonding is performed at a temperature below 30° C., the first anode part 20, the double-sided electrode 100, and the first cathode part 40 may be connected poorly. When the thermal bonding is performed at a temperature above 160° C., the first anode part 20, the double-sided electrode 100, or the first cathode part 40 may be damaged by heat. According to an embodiment, the first anode part 20, the double-sided electrode 100, and the first cathode part 40 are manufactured and subsequently connected by thermal bonding, and thus a lithium battery may be easily manufactured.

A third pouch film 200 may be provided on a sidewall of the first anode part 20, a sidewall of the double-sided electrode 100, and a sidewall of the first cathode part 40. The third pouch film 200 may include the same material as the first and second pouch films 10 and 30. The third pouch film 200 may be connected to the first and second pouch films 10 and 30. The first anode part 20, the double-sided electrode 100, and the first cathode part 40 may be sealed by the first, second, and third pouch films 10, 30, and 200. Accordingly, the first anode part 20, the double-sided electrode 100, and the first cathode part 40 may be prevented from being damaged by external air and moisture. A lithium battery may have a long lifetime and good safety characteristics.

According to an embodiment, the second cathode part 120 is disposed on the first pouch film 10 and the second anode part 110 is disposed on the second pouch film 30, and thus a process of attaching the pouch films 10 and 30 may be omitted.

The first anode part 20 and the second cathode part 120 may form a first unit cell UB1. The second anode part 110 and the first cathode part 40 may form a second unit cell UB2. The second unit cell UB2 may have the same structure and material, and thus realize the same electrical performance (for example, capacity and voltage) as the first unit cell UB1. The second unit cell UB2 and the first unit cell UB1 may be connected in parallel through the anode connector 150 and the cathode connector 140. A capacity of a lithium battery may be equal to a sum of the capacities of the first and second unit cell UB1 and UB2. A voltage of a lithium battery may be equal to a voltage of the first unit cell UB1. In accordance with a method of manufacturing a lithium battery according to an embodiment of the inventive concept, a lithium battery having a higher capacity may be easily manufactured. Current leakage between the first unit cell UB1 and the second unit cell UB2 may be prevented (or reduced) by the polymer film 130. The electrolyte layers are a solid, and the second anode electrolyte layer 116 and the second cathode electrolyte layer 126 may be disposed to not cover a sidewall of the polymer film 130 (for example, the third surface 131C of the polymer film 130). Accordingly, current leakage between the first unit cell UB1 and the second unit cell UB2 may be prevented (or reduced) further. An additional pouch film (not shown) is not disposed between the first unit cell UB1 and the second unit cell UB2, and thus a lithium battery may become smaller.

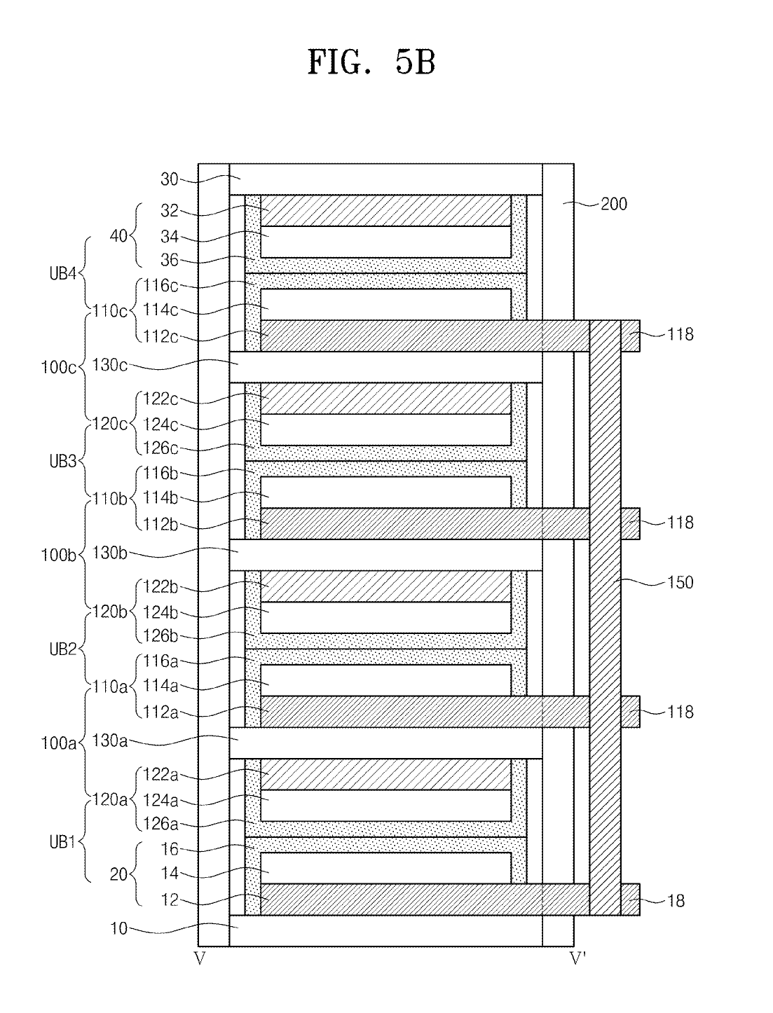

FIG. 5A is a cross-sectional view taken along line IV-IV′ of FIG. 4A, illustrating a lithium battery according to another embodiment of the inventive concept. FIG. 5B is a cross-sectional view taken along line V-V′ of FIG. 4A, illustrating a lithium battery according to another embodiment of the inventive concept.

Any repetition of the above detailed description will hereinafter be omitted.

Referring to FIGS. 5A and 5B, a lithium battery may be manufactured by connecting in parallel the first cathode part 40, a plurality of double-sided electrodes 100A, 100B, and 100C, and the first anode part 20. The first anode part 20 may be manufactured using the method as described in the example of FIGS. 1A and 1B. The first cathode part 40 may be manufactured by the method as described in the examples of FIGS. 2A and 2B. Each of the plurality of double-sided electrodes may include the first to third double-sided electrodes 100A, 100B, and 100C. The first to third double-sided electrodes 100A, 100B and 100C may be manufactured using the method as described in the example of the double-sided electrode 100 of FIGS. 3A and 3B. Accordingly, the first to third double-sided electrodes 100A, 100B, and 100C may have the same structure and material. The first cathode part 40, the first to third double-sided electrodes 100A, 100B, and 100C, and the first anode part 20 may be connected in the same manner as described in FIGS. 4A and 4B. A lithium battery may be formed by laminating the plurality of double-sided electrodes 100A, 100B, and 100C and the first cathode part 40 on the first anode part 20. The first double-sided electrode 100A may be disposed on the first anode part 20, so that the second cathode part 120A of the first double-sided electrode 100A contacts the first anode part 20. Subsequently, the first double-sided electrode 100A may be disposed on the second anode part 120B such that the second cathode part 120B of the second double-sided electrode 100B contacts the second anode part 110A of the first double-sided electrode 100A. The third double-sided electrode 100C may be disposed on the second double-sided electrode 100B such that the second cathode part 120C of the third double-sided electrode 100C contacts the second anode part 110B of the second double-sided electrode 100B. The first cathode part 40 may be disposed on the third double-sided electrode 100C, so that the first cathode part 40 contacts the second anode part 110C of the third double-sided electrode 100C. The first anode part 20, the first to third double-sided electrodes 100A, 100B, and 100C, and the first cathode part 40 may be interconnected by thermal bonding. The second anode electrolyte layers 116A, 116B, and 116C and the second cathode electrolyte layers 126A, 126B, and 126C of each of the double-sided electrodes 100A, 100B, and 100C may be a solid, and may be disposed to not cover sidewalls of the polymer films 130A, 130B, and 130C. As illustrated in FIG. 4A, the first cathode terminal 38, the second cathode terminals 128, the first anode terminal 18, and the second anode terminals 118 may protrude from the first pouch film 10. When viewed from the top, the first and second cathode terminals 38 and 128 may overlap each other. The cathode connector 140 may penetrate the first cathode terminal 38 and the second cathode terminal 128 to be connected to the first and second cathode terminals 38 and 128. The first and second anode terminals 18 and 118 may overlap each other, and be spaced apart from the first and second cathode terminals 38 and 128, in a horizontal direction. The anode connector 150 may penetrate the first anode terminal 18 and the second anode terminal 118 to be connected to the first and second anode terminals 18 and 118.

According to an embodiment, a lithium battery may include the first to fourth unit cells UB1 to UB4. The first anode part 20, and the second cathode part 120A of the first double-sided electrode 100A may form the first unit cell UB1. The second anode part 110A of the first double-sided electrode 100A, and the second cathode part 120B of the second double-sided electrode 100B may form the second unit cell UB2. The second anode part 110B of the second double-sided electrode 100B, and the second cathode part 120C of the third double-sided electrode 100C may form the third unit cell UB3. The second anode part 110C of the third double-sided electrode 100C, and the first cathode part 40 may form the fourth unit cell UB4. A plurality of double-sided electrodes 100A, 100B, and 100C may be provided, and therefore each of the polymer films 130A, 130B, and 130C may be disposed between each of the unit cells UB1 to UB4. The unit cells UB1 to UB4 may be connected in parallel through the cathode connector 140 and the anode connector 150. The first to fourth unit cells UB1 to UB4 may have the same electrical properties (for example, capacity and voltage). Since the first to fourth unit cells UB1 to UB4 are connected in parallel, a capacity of a lithium battery is equal to a sum of the capacities of the first to fourth unit cells UB1 to UB4. For example, a capacity of a lithium battery may be equal to four times the capacity of the first unit cell UB1. A voltage of a lithium battery may be equal to the voltage of the first unit cell UB1. According to an embodiment, a high capacity lithium battery may be easily manufactured by adjusting number of the double-sided electrodes. A capacity of a lithium battery may also be controlled by adjusting number of the double-sided electrodes 100A, 100B and 100C. The pouch films 10, 30 and 200 may protect the unit cells from the external environment.

Hereinafter, a method of manufacturing a lithium battery according to an embodiment of the inventive concept and evaluation results of the lithium battery are described in detail with reference to Experimental Examples.

### Manufacturing of Lithium Battery

### Experimental Example 1

### Manufacturing of Electrolyte Paste

A polymer matrix is produced by dissolving ethyl cellulose in N-methyl pyrrolidone (NMP), and then dissolving a copolymer of vinylidene fluoride and hexafluoro propylene. Ethyl cellulose and the copolymer have a weight ratio of about 30:70. Lithium hexafluoro phosphate (LiPF₆) is dissolved in an organic solvent to produce a non-aqueous electrolyte solution having a concentration of about 1 mol/L. The organic solvent is produced by mixing ethylene carbonate (EC), propylene carbonate (PC), and ethyl methyl carbonate (EMC) at a weight ratio of about 1.5:1:1.5. The non-aqueous electrolyte solution and lithium aluminum titanium phosphate (LATP), in an amount of 300 wt % and 50 wt % of the polymer matrix respectively, are sequentially added to the polymer matrix. Thereafter, stirring is performed.

(Manufacturing of First Anode Part)

A method of manufacturing a first anode part is described with reference to FIGS. 1A and 1B.

A nylon layer, an aluminum foil, and a cast polypropylene layer are laminated to form a first pouch film 10. The first pouch film 10 is subjected to surface treatment using a corona discharger under atmospheric conditions until the surface energy of the first pouch film 10 is 60 dyne/cm or more.

A copper foil having a thickness of about 8 μm is laminated on the first pouch film 10 to form a first anode current collector 12 on the first pouch film 10. The lamination is performed at a temperature of about 130° C., after a hot melt adhesive film is inserted between the first pouch film 10 and the copper foil. An anode terminal 18 is formed on the first pouch film 10 and connected to the copper foil.

An anode paste, produced by mixing electrolyte paste, natural graphite, and acetylene black at about 10 wt %, 85 wt % and 5 wt % respectively, is used. The electrolyte paste is produced as described above. The anode paste is coated with a thickness of about 65 μm on the first anode current collector 12 to form a first anode layer 14. Subsequently, the electrolyte paste is coated on the first anode layer 14 to produce a first electrolyte layer 16.

(Manufacturing of First Cathode Part)

A method of manufacturing a first cathode part is described with reference to FIGS. 2A and 2B.

As similar to the first anode part 20, a first cathode part 40 is formed on a second pouch film 30. However, an aluminum foil having a thickness of about 10 μm, a width of about 120 mm, and a height of about 87 mm is used as a first cathode current collector 32. Electrolyte paste, lithium cobalt oxide (LiCoO₂), and acetylene black are mixed at about 10 wt %, 85 wt %, and 5 wt % respectively to produce a cathode paste. The electrolyte paste is produced as described above. The cathode paste is coated with a thickness of about 100 μm on the copper current collector to produce a first cathode layer 34. The electrolyte paste is coated directly on the first cathode layer 34 to produce a first cathode electrolyte layer 36.

(Manufacturing of Double-sided Electrode)

Hereinafter, a method of manufacturing a double-sided electrode is described with reference to FIGS. 3A and 3B.

A cast polypropylene (c-PP) film having a thickness of about 150 μm is prepared. A copper foil is positioned on a first surface of the c-PP film, and an aluminum foil is positioned on a second surface of the c-PP film. The copper foil and the c-PP film are laminated, and also the aluminum foil and the c-PP film are laminated. A second cathode layer 124 and a second cathode electrolyte layer 126 are formed on an aluminum film in the same manner as the first anode layer 14 and the first anode electrolyte layer 16. A second anode layer 114 and a second anode electrolyte layer 116 are formed on the copper film in the same manner as the first anode layer 14 and the first anode electrolyte layer 16.

(Manufacturing of Lithium Battery)

Hereinafter, a method of manufacturing a lithium battery is described with reference to FIGS. 4A to 4C.

The first anode part 20, the double-sided electrode 100, and the first cathode part 40 are laminated. The first anode electrolyte layer 16 of the first anode part 20 is disposed to face the second cathode electrolyte layer 126 of the double-sided electrode 100. The first cathode electrolyte layer 36 of the first cathode part 40 is disposed to face the second anode electrolyte layer 116 of the double-sided electrode 100. The first anode part 20, the double-sided electrode 100, and the first cathode part 40 are thermally bonded and laminated at a temperature of about 130° C. C. A cathode connector 140 connecting the cathode terminals 38 and 128 was formed, and an anode connector 150 connecting the anode terminals 18 and 38 was formed.

### Experimental Example 2

A lithium battery may be manufactured using the same method as used in Experimental Example 1. However, electrolyte paste, olivine, and acetylene black are mixed at a ratio of about 10 wt %, 85 wt %, and 5 wt % respectively to produce the cathode paste.

### Comparative Example 1

### Manufacturing of Electrolyte Paste

An electrolyte paste manufactured using the same method as used in Experimental Example 1 was used.

(Manufacturing of First Anode Part)

A first anode part 20 was manufactured using the same method used in Experimental Example 1. A first pouch film 10, and a first anode current collector 12 on the first pouch film 10 were not provided. A first anode layer 14 and a first anode electrolyte layer 16 were formed sequentially on a copper foil.

(Manufacturing of First Cathode Part)

A first cathode part 40 was manufactured using the same method as used in Experimental Example 1. However, a second pouch film 30, and a first cathode current collector 32 on the second pouch film 30 were not provided. A first cathode layer 34 and a first cathode electrolyte layer 36 were formed sequentially on an aluminum foil.

(Manufacturing of Double-Sided Electrode)

A double-sided electrode 100 was manufactured using the same method as used in Experimental Example 1. However, nickel foil was used instead of a c-PP film.

(Manufacturing of Lithium Battery)

A lithium battery was manufactured using the same method as used in Experimental Example 1. However, the first anode part 20, the first cathode part 40 and the double-sided electrode 100 manufactured in Comparative Example 1 were used. Cathode rivets were omitted, and the cathode terminals 38 and 128 were connected through ultrasonic welding. Anode rivets were omitted, and the anode terminals 18 and 118 were connected through ultrasonic welding.

### Comparative Example 2

A lithium battery was manufactured using the same method as used in Comparative Example 1. However, electrolyte paste, olivine(LiFePO₄), and acetylene black were mixed at a ratio of about 10 wt %, 85 wt %, and 5 wt % respectively to produce the cathode paste.

Evaluation of Lithium Battery Performance

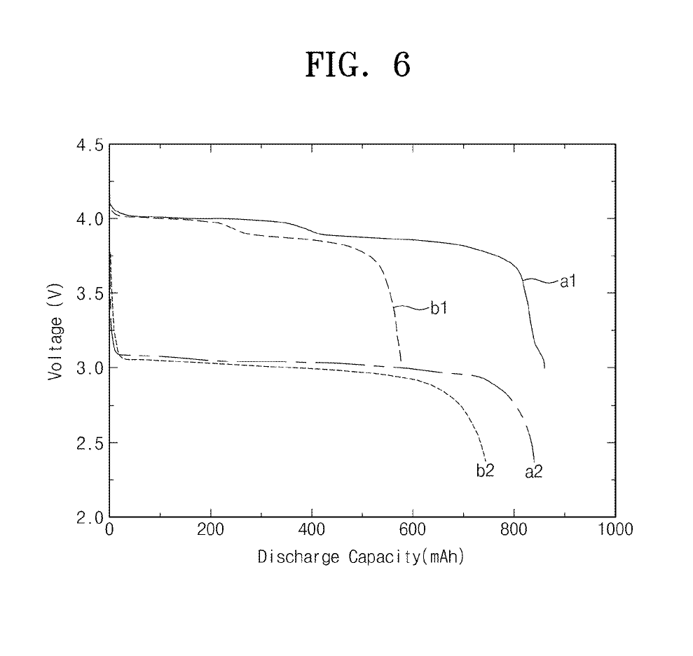

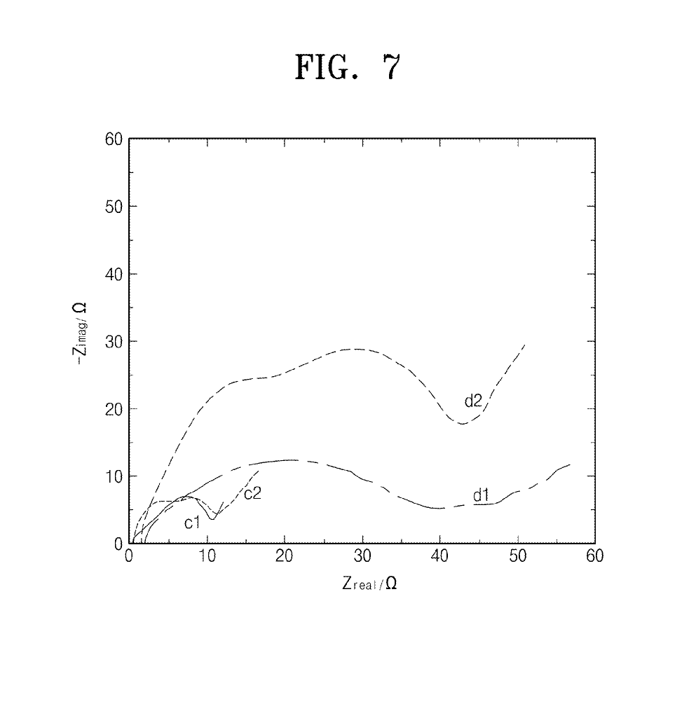

FIG. 6 is a graph showing evaluation results of discharge characteristics of the lithium batteries according to Experimental Examples and Comparative Examples. Discharge characteristics were evaluated by discharging the lithium batteries and measuring the discharge capacity (horizontal axis) versus the voltage (vertical axis). Hereinafter, description is given with reference to FIGS. 4A to 4C.

Referring to FIG. 6, Experimental Example 1 (a1) has a larger discharge capacity than Comparative Example 1 (b1) and Comparative Example 2 (b2), and Experimental Example 2 (a2) has a larger discharge capacity than Comparative Example 2 (b2). Each unit cell of the Experimental Examples (a1 and a2) is thermally bonded individually in a vacuum, using a pocketing method. Subsequently, the cathode terminals 38 and 128 and the anode terminals 18 and 118 are connected in parallel using a riveting method. Consequently, the Experimental Examples (a1 and a2) have a much lower internal resistance than the Comparative Examples (b1 and b2), and the electrolyte layer is directly printed on the electrode layer so that the contact between the electrode layer and the electrolyte is maximized Therefore, compared to the Comparative Examples (b1 and b2), the solid-state lithium batteries in the Experimental Examples (a1 and a2) have enhanced performance in that the voltage drop due to the interfacial resistance properties of the solid-state lithium batteries is reduced.

FIG. 7 is a graph showing evaluation results of impedance characteristics of the lithium batteries according to Experimental Examples and Comparative Examples. Hereinafter, a description is given with reference to FIGS. 4A to 4C.

Referring to FIG. 7, Experimental Example 1 (d1) has a lower internal resistance than Comparative Example 1 (e1), and Experimental Example 2 (d2) has a lower internal resistance than Comparative Example 2 (c2). In the lithium batteries of the Comparative Examples (e1 and c2), a polymer film 130 is omitted which allows a small leakage current to flow between the first unit cell UB1 and the second unit cell UB2, and thus the impedance is low. In the Experimental Examples (d1 and d2, a polymer film 130 may be provided between the first unit cell UB1 and the second unit cell UB2. The polymer film 130 may include an insulating material, and the electrolyte layers 116 and 126 of the double-sided electrode 100 may be disposed to not cover the sidewalls (for example, a third surface 131C) of the polymer film 130. Accordingly, the second cathode electrolyte layer 126 of the first unit cell UB1 may be electrically insulated from the second anode electrolyte layer 116 of the second unit cell UB2. Accordingly, a leakage current may be prevented from flowing between the first and second unit cells UB1 and UB2 of a lithium battery. In the lithium batteries of the Experimental Examples (d1 and d2), the electrolyte may be coated directly on the electrode, all of the unit cells may be thermally bonded during stacking of cells, and thus physical contact within the cells and between cells may be maximized Physical voids at each of the interfaces may also be minimized, thus strengthening the adhesion.

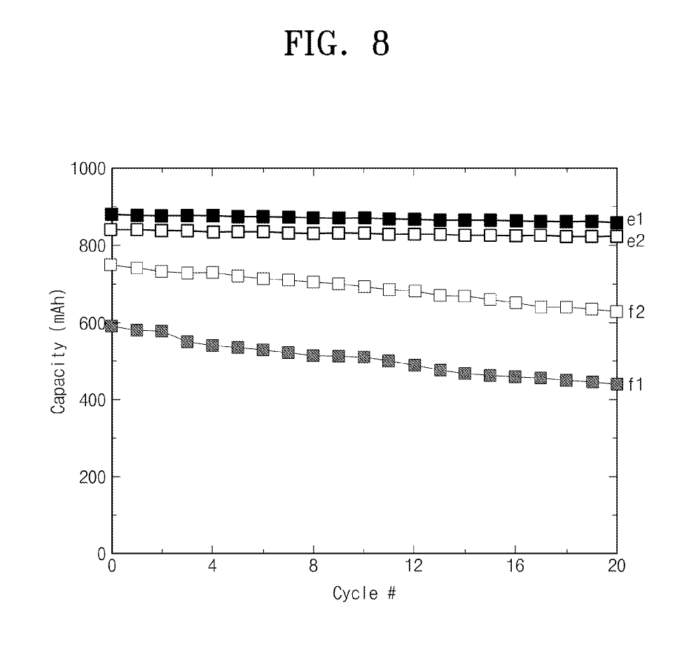

FIG. 8 is a graph showing evaluation results of lifetime characteristics of the lithium batteries according to Experimental Examples and Comparative Examples.

Referring to FIG. 8, for an identical cycle, Experimental Example 1 (e1) has a higher capacity than Comparative Example 1 (f1), and Experimental Example 2 (e2) has a higher capacity than Comparative Example 2 (f2). As described above with reference to FIGS. 6 and 7, the Experimental Examples (e1 and e2) have a lower internal resistance and improved voltage drop characteristics compared to the Comparative Examples (f1 and f2). As number of cycles increases, the capacity of the Experimental Examples (e1 and e2) is relatively stable, whereas the capacity of the Comparative Examples (f1 and f2) may be observed to decline. Accordingly, the Experimental Examples (e1 and e2) show superior lifetime characteristics compared to the Comparative Examples (f1 and f2). The Experimental Examples may have improved voltage drop characteristics. Accordingly, the lithium battery is shown to have a long lifetime and stability.

While the inventive concept has been described in detail with reference to exemplary embodiments thereof, it should be understood that the inventive concept is not limited by the above embodiments, and it is possible for a person of ordinary skill in the art to make various modifications or changes without departing from the technical spirit and scope of the inventive concept.

According to an embodiment of the inventive concept, a lithium battery includes a first unit cell and a second unit cell. Herein, the first unit cell has a first anode part provided with a first anode terminal, and a second cathode part provided with a second cathode terminal, and the second unit cell has a first cathode part provided with a first cathode terminal, and a second anode part provided with a second anode terminal. An anode connector may provide a connection between the first and second anode terminals using riveting, and a cathode connector may provide a connection between the second and first cathode terminals using riveting. Therefore, since it is possible to omit spot welding or ultrasonic welding which is used to provide a connection between the first and second unit cells, a simple method of manufacturing a lithium battery may be possible and the unit cells may be packed more densely.

What is claimed is:

1. A lithium battery, comprising:
a first pouch film;
a first anode part on the first pouch film, the first anode part including a first anode terminal;
a second cathode part on the first anode part;
a polymer film on the second cathode part;
a second anode part on the polymer film, the second anode part including a second anode terminal;
a first cathode part on the second anode part;
a second pouch film on the first cathode part; and
an anode connector configured to penetrate the first and second anode terminals to provide an electrical connection between the first anode part and the second anode part.

2. The lithium battery of claim 1, wherein:
the polymer film comprises a first surface and a second surface opposite to the first surface, the first surface facing the first pouch film;
the first anode part comprises a first anode current collector, a first anode layer, and a first anode electrolyte layer which are laminated on the first pouch film;
the second cathode part comprises a second cathode current collector, a second cathode layer, and a second cathode electrolyte layer which are laminated on the first surface of the polymer film;
the second anode part comprises a second anode current collector, a second anode layer and a second anode electrolyte layer which are laminated on the second surface of the polymer film; and
the first cathode part comprises a first cathode current collector, a first cathode layer, and a first cathode electrolyte layer which are laminated on the second pouch film.

3. The lithium battery of claim 2, wherein:
the first anode electrolyte layer faces and contacts the second cathode electrolyte layer; and
the second anode electrolyte layer faces and contacts the first cathode electrolyte layer.

4. The lithium battery of claim 2, wherein the first anode electrolyte layer includes the same material as the first cathode electrolyte layer, the second anode electrolyte layer and the second cathode electrolyte layer.

5. The lithium battery of claim 2, wherein:
the polymer film comprises a third surface configured to connect the first surface to the second surface; and
the third surface of the polymer film is not covered by the second cathode electrolyte layer and the second anode electrolyte layer.

6. The lithium battery of claim 2, wherein:
each of the second cathode part, the second anode part and the polymer film is provided in plurality, in which the second cathode electrolyte layer of each of the second cathode parts faces and contacts the second anode electrolyte layer of each of the second anode parts that are adjacent to the second cathode parts.

7. The lithium battery of claim 1, wherein:
the first cathode part comprises a first cathode terminal; and
the second cathode part comprises a second cathode terminal;
the lithium battery further comprising a cathode connector configured to penetrate the first cathode terminal and the second cathode terminal to provide an electrical connection between the first cathode part and the second cathode part.

8. The lithium battery of claim 7, wherein the first anode part and the second cathode part form a first unit cell, and the second anode part and the first cathode part form a second unit cell,
the first unit cell being connected to the second unit cell in parallel.

9. The lithium battery of claim 8, wherein the first unit cell has the same voltage and capacity as the second unit cell.

10. The lithium battery of claim 2, wherein:
the first anode terminal is connected, on the first pouch film, to the first anode current collector, and
protrudes horizontally from the first anode current collector; and
the second anode terminal is connected, on the polymer film, to the second anode current collector, and protrudes horizontally from the second anode current collector.

11. The lithium battery of claim 2, wherein:
the first cathode part comprises a first cathode terminal; and
the second cathode part comprises a second cathode terminal,
wherein the first cathode terminal is connected, on the second pouch film, to the first cathode current collector, and protrudes horizontally from the first cathode current collector, and
the second cathode terminal is connected, on the polymer film, to the second cathode current collector, and protrudes horizontally from the second cathode current collector.

12. The lithium battery of claim 1, wherein:
each of the second cathode part, the second anode part and the polymer film is provided in plurality, number of the second cathode parts being equal to number of the second anode parts and number of the polymer films; and
each of the polymer films is disposed between one of the second cathode parts and one of the second anode parts.

13. A method for manufacturing a lithium battery, the method comprising:
forming a first anode part on a first pouch film, the first anode part including a first anode current collector, a first anode terminal, a first anode layer and a first anode electrolyte layer which are laminated on the first pouch film;
forming a first cathode part on a second pouch film, the first cathode part including a first cathode current collector, a first cathode terminal, a first cathode layer and a first cathode electrolyte layer which are laminated on the second pouch film;
providing a double-sided electrode, the double-sided electrode including a polymer film having a first surface and a second surface, a second cathode part which is disposed on the first surface and has a second cathode terminal, and a second anode part which is disposed on the second surface and has a second anode terminal;
connecting the first cathode part, the first anode part and the double-sided electrode;
forming an anode connection that penetrates the first anode terminal and the second anode terminal to connect the first anode terminal and the second anode thermal, and a cathode connection that penetrates the first cathode terminal and the second cathode terminal to connect the first cathode terminal and the second cathode terminal.

14. The method of claim 13, wherein the first anode part and the second cathode part form a first unit cell, and the second anode part and the first cathode part form a second unit cell,
the first unit cell being connected to the second unit cell in parallel through the cathode connection and the anode connection.

15. The method of claim 13, wherein the providing of the double-sided electrode comprises:
forming the second cathode part by laminating, on the first surface of the polymer film, a second cathode current collector, a second cathode layer and a second cathode electrolyte layer; and
forming the second anode part by laminating, on the second surface of the polymer film, a second anode current collector, a second anode layer and a second anode electrolyte layer.

16. The method of claim 13, wherein the connecting of the first cathode part, the first anode part and the double-sided electrode comprises thermally bonding the first cathode part, the first anode part, and the double-sided electrode at a temperature in the range of about 100° C. to about 160° C.

17. The method of claim 15, wherein:
the polymer film has a third surface configured to connect the first surface to the second surface, and
the third surface is not covered by the second cathode electrolyte layer and the second anode electrolyte layer.

18. The method of claim 15, wherein:
the first anode electrolyte layer faces and contacts the second cathode electrolyte layer; and
the second anode electrolyte layer faces and contacts the first cathode electrolyte layer.

19. The method of claim 15, wherein the first anode electrolyte layer, the first cathode electrolyte layer, the second anode electrolyte layer, and the second cathode electrolyte layer include the same material.
